(19) United States
(12) Patent Application Publication
(10) Pub. No.: US 2017/0238370 A1
(43) Pub. Date: Aug. 17, 2017

(54) Flexible Small-Diameter Self-Regulating Heater Cable

(71) Applicant: Pentair Thermal Management LLC, Redwood City, CA (US)

(72) Inventors: Pete Pretorius, Langley (CA); Alice Liang, White Rock (CA); Patrick Mann, Coquitlam (CA)

(21) Appl. No.: 15/433,907

(22) Filed: Feb. 15, 2017

Related U.S. Application Data
(60) Provisional application No. 62/295,382, filed on Feb. 15, 2016.

(51) Int. Cl. H05B 3/56; H05B 3/14

(52) U.S. Cl. CPC H05B 3/56; H05B 3/146; H05B 2203/02; H05B 2203/026

(57) ABSTRACT

A heater cable, which may particularly be a self-regulating heater cable, has a heating element including two bus wires spaced a distance apart by a positive temperature coefficient (PTC) material, giving the heating element a major axis and a minor axis. Bending the heater cable transverse to the major axis gives a tighter bend radius than bending the heater cable transverse to the minor axis. To facilitate bending in multiple directions, the heating element is twisted around the longitudinal axis of the heater cable. The twisting may be done uniformly to give the bus wires a helical configuration, which reduces electromagnetic interference and facilitates heater cable diameters as small as 0.25 inches. Additional layers, such as polymer jackets and a braided metal ground plane layer, may be added over the heating element. Each of these layers may be twisted or untwisted in various implementations.

### CROSS-REFERENCE TO RELATED APPLICATIONS

This application is a non-provisional claiming priority to U.S. Prov. Pat. App. Ser. No. 62/295,382, filed under the same title on Feb. 15, 2016, and incorporated fully herein by reference.

### FIELD OF THE INVENTION

The present invention generally relates to heater cables, and more specifically to self-regulating heater cables.

### BACKGROUND OF THE INVENTION

Heater cables, such as self-regulating heater cables, tracing tapes, and other types, are cables configured to provide heat in applications requiring such heat. In some approaches, a heater cable operates by use of a pair or more of bus, wires having a high conductance coefficient (i.e., low resistance). The bus wires are coupled to differing voltage supply levels to create a voltage potential between them. A positive temperature coefficient (PTC) material is often situated between the bus wires and current is allowed to flow through the PTC material, thereby generating heat. As the temperature increases, so does the resistance of the PTC material, thereby reducing the current therethrough and the heat generated. The heater cable is thus self-regulating in terms of the amount of thermal energy (i.e., heat) output by the cable.

Heater cables offer the benefit of being field-configurable. By this, heater cables may be applied or installed as needed without the requirement that application-specific heating assemblies be custom-designed and manufactured, though heater cables may be specifically designed for application-specific uses in some instances. One example application is in underfloor heating. Heater cables can be installed below the finished flooring layer in a configuration that provides a desired amount of thermal transmission from the heater cables to the flooring. Typically, the heater cable is laid on a subfloor or a cable retaining device in a serpentine path below the area of the floor to be heated. The heater cable and retaining device, if any, are covered with thinset or another flooring adhesive, and the finished flooring layer is adhered over the top.

### BRIEF DESCRIPTION OF THE DRAWINGS

FIG. 1 is a perspective view of a heater cable in accordance with various embodiments of the present disclosure;

FIG. 2A is a cross-sectional diagram of an exemplary heating element in accordance with various embodiments of the present disclosure;

FIG. 2B is a cross-sectional diagram of another exemplary heating element in accordance with various embodiments of the present disclosure;

FIG. 2C is a cross-sectional diagram of another exemplary heating element in accordance with various embodiments of the present disclosure;

FIG. 2D is a cross-sectional diagram of another exemplary heating element in accordance with various embodiments of the present disclosure;

FIG. 3 is a cross-sectional diagram of the heater cable of FIG. 1, taken along line 3-3 of FIG. 1;

FIG. 4 is a cross-sectional diagram of the heater cable of FIG. 1, taken along line 4-4 of FIG. 1;

FIG. 5 is a cross-sectional diagram of another exemplary embodiment of a heater cable in accordance with the present disclosure; and

FIG. 6 is a cross-sectional diagram of the heater cable of FIG. 5, taken at a different point along the heater cable.

### DETAILED DESCRIPTION

The present disclosure provides, in various embodiments, a self-regulating heater cable having, relative to existing self-regulating heater cables, a very small diameter and a high degree of flexibility. Additionally, arrangements of the heater cable components provide a reduced emission by the heater cable of electromagnetic interference (EMI) compared to known similar solutions. The heater cable is particularly suited for underfloor heating applications, wherein the small diameter can minimize the increase in floor height needed to accommodate the heating apparatus, the flexibility makes the heater cable easier to install and harder to damage in a serpentine configuration, and the lower EMI reduces interference with electronic components disposed on or near the heated floor. The heater cable can include one or more flexible jackets that are impermeable to water and/or to typical flooring adhesives, to further make the heater cable suitable for underfloor heating.

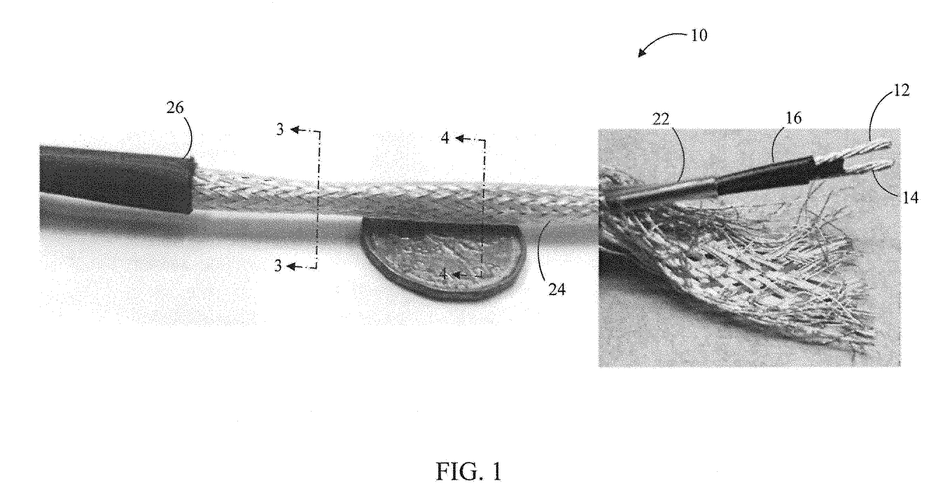

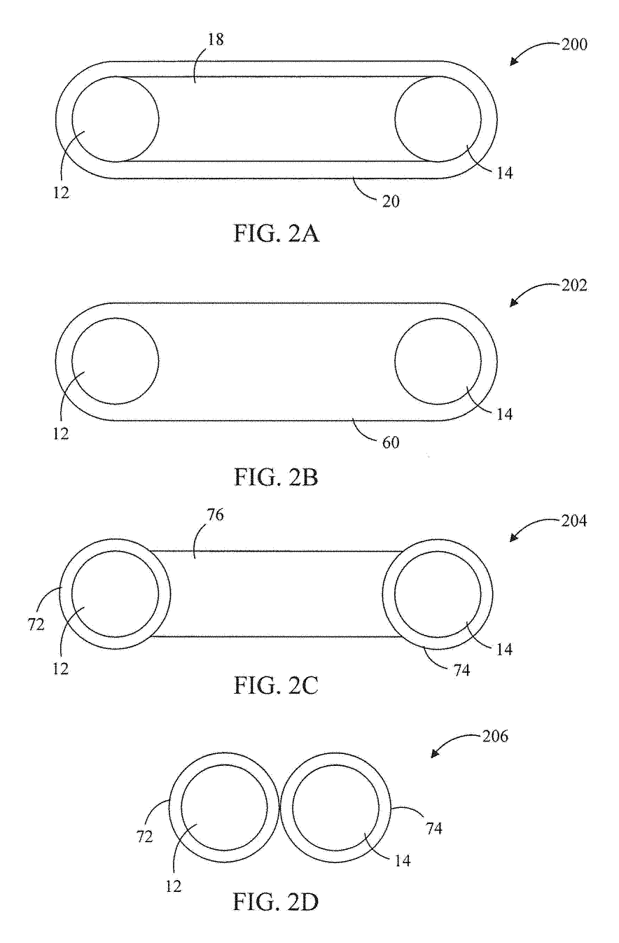

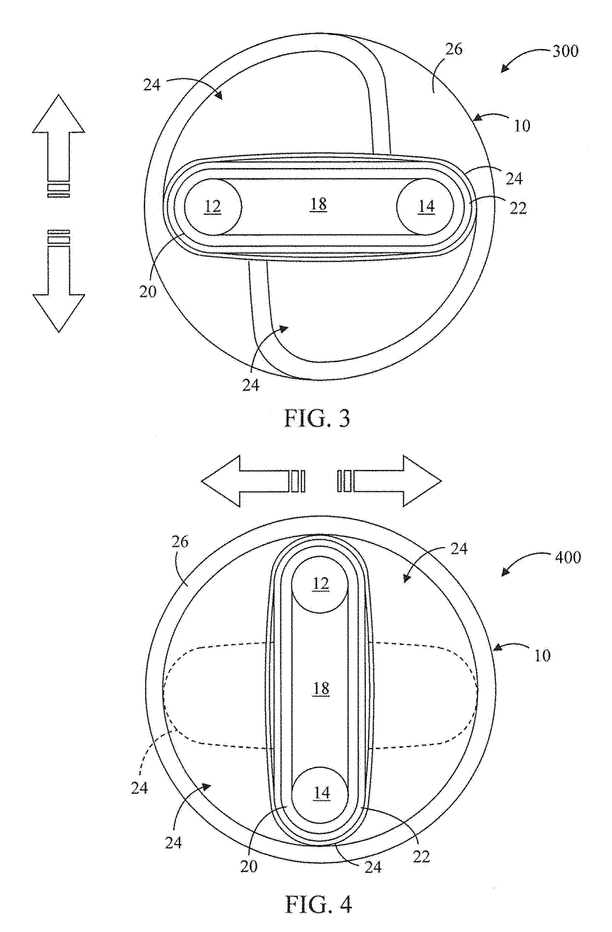

FIGS. 1-4 illustrate a heater cable 10 in accordance with various embodiments. In FIG. 1, the illustrated heater cable 10 is shown with each layer subsequently stripped to clearly illustrate its construction in accordance with at least one embodiment. In one approach, the heater cable 10 includes a first bus wire 12 and a second bus wire 14. The bus wires 12, 14 may be of any suitable conductive material including copper, aluminum, steel, gold, platinum, silver, and others, The bus wires 12, 14 may be solid conductor wires or may be stranded wire. The bus wires 12, 14 may be spaced apart by, and in direct electrical contact with, a conductive positive temperature coefficient (PTC) material 16. The bus wires 12, 14 and PTC material 16 together form the heating element of the heater cable 10. In one embodiment, shown in FIG, 2A, the bus wires 12, 14 may be separated by a PTC core 18, and may further be encapsulated together, with the PTC core 18, within a PTC layer 20 to form the heating element 200. In another embodiment, shown in FIG. 2B, the bus wires 12, 14 may be encapsulated within and spaced apart by a monolithic PTC core 60 to form a monolithic heating element 202. The portion of the monolithic PTC core 60 between the bus wires 12, 14 may be any suitable width for generating heat as described below.

In another embodiment, shown in FIGS, 2C and 2D, the first bus wire 12 may be individually encapsulated within a first PTC layer 72, and the second bus wire 14 may be individually encapsulated within, a second PTC layer 74. A PTC core 76 may space apart the encapsulated bus wires 12, 14, as shown in the heating element 204 of FIG. 2C, or the bus wires 12, 14 may be spaced apart by the thicknesses of the PTC layers 72, 74, as shown in the heating element 206 of FIG. 2D. In embodiments having multiple discrete layers of PTC material (e.g., the embodiments of FIG. 2A, 2C, and 2D), the PTC material may be the same material in all layers, or may be different materials. Such layers may be adhered together at mutual contact points during manufacturing, or may be held in contact by friction within the completed heater cable 10, or may be allowed to move freely with respect to each other, according to various embodiments. The heating element may be formed by extrusion, co-extrusion, molding, dipping, or any other suitable manufacturing method of combination of methods.

In use, a voltage potential is provided across the bus wires 12, 14 via a power supply or power source (not shown), which voltage potential may be of alternating current (AC) or direct current (DC). The application of this voltage differential results in a current flow through the PTC material from the first bus wire 12 to the second bus wire 14, or vice versa. This current interacts with the PTC material to generate heat in accordance with the resistance characteristics of the PTC material. The PTC material(s), in any configuration, thereby act as a heating element within the heater cable 10, as it has a substantially higher resistance than the conductors of the bus wires 12, 14 (which have negligible resistances). The PTC material also limits the current passed through the PTC materials based on the temperature of the PTC material. The PTC material has a positive temperature coefficient, meaning the electrical resistance of the material increases as its temperature increases. As the resistance of the PTC material increases, the current decreases and the heat locally generated by the flow of current resultantly decreases. So configured, the heater cable 10 is self-regulating in that the resistance of the PTC core 16 varies with temperature.

According to various embodiments and application settings, the PTC material of any of the above-described components may be formed of a polymer filled with electrically conductive materials including, for example, polymer-carbon compound such as PFA, carbon black compounds, polyolefins (including but not limited to polyethylene (PE), polypropylene (PP), polymethylpentene (PMP), polybutene (PB), polyolefin elastomers (POE), etc.), Fluoropolymers (ECA from DuPont™, Teflon® from DuPont™, perfluoroalkoxy polymers (PFA, MFA), polyethylenetetrafluoroethylene (ETFE), polyethylenechlorotrifluoroethylene (ECTFE), fluorinated ethylene-propylene (FEP), polyvinylidene fluoride (PVDF, homo and copolymer variations), Hyflon® from Solvay™ (e.g., P120X, 130X and 140X), polyvinylfluoride (PVF), polytetrafluoroethylene (PTFE), fluorocarbon or chlorotrifluoroethylenevinylidene fluoride (FKM), perfluorinated elastomer (FFKM)), and their mixtures.

In some embodiments, the heater cable 10 may have a very small diameter, with respect to known self-regulating heater cables. The heater cable 10 may, for example, have an outer diameter of about 0.25 inches. To accomplish this, the distance between the bus wires 12, 14, measured from the center of each wire, may be minimized. In one embodiment, the center-to-center distance between the bus wires 12, 14 may be about 0.06 inches (1.5 mm) to enable a cable outer diameter of 0.25 inches. The minimum achievable center-to-center distance may depend on, among other things, manufacturing methods, material selection, target circuit length, and thermal management considerations (e.g. operating temperature range, uniformity of heat radiation, etc.).

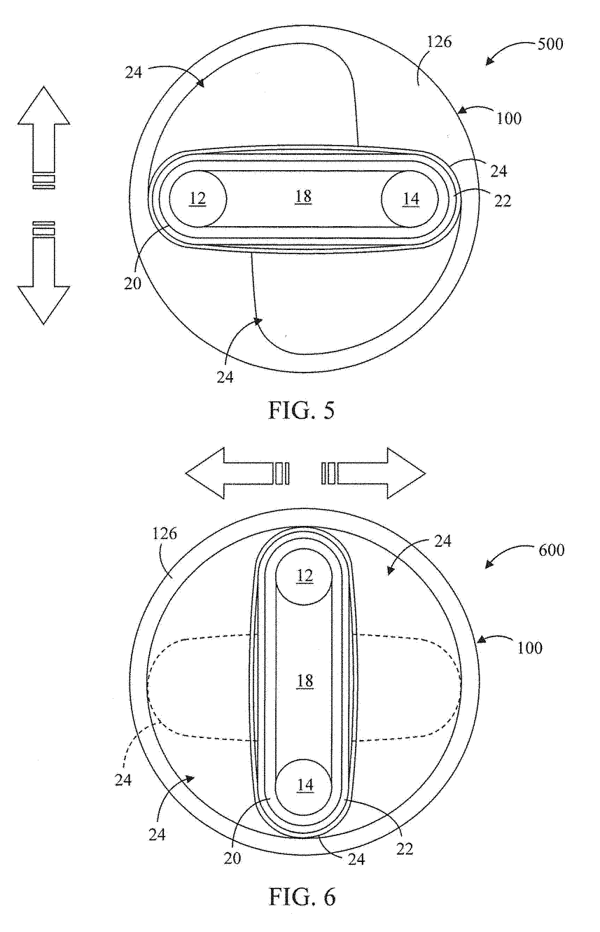

Due to the shape of the heating element in a typical self-regulating heater cable, with two bus wires side-by-side and separated a certain distance, the typical self-regulating heater cable has a cross-section that is ovoid or “stadium”-shaped (i.e., a rectangle with a semicircle at each end). Such cables may have a relatively good bend radius when bent in the plane of the minor cross-sectional axis, but a very poor bend radius when bent in the plane of the major cross-section axis. Moreover, such cables can stress and break when improperly bent. In the present heater cable 10, the heating element may be twisted, or rotated helically around its longitudinal axis, along the length of the heater cable 10. To be clear, in some embodiments, the longitudinal axis may be disposed directly between the bus wires 12, 14, at the midpoint of the distance between them. The twisting creates a helical arrangement of the parallel bus wires 12, 14, such that the plane minor cross-sectional axis of the heating, element, which enables the favorable bend radius, is constantly rotating in the twisted portions of the heater cable 10. As shown in the exemplary cross-sections of the heater cable 10 in FIGS. 3 and 4, this allows the heater cable 10 to be bent in multiple directions (demonstrated by arrows for a first orientation 300 of FIG. 3 and a second orientation 400 of FIG. 4) without damage or stress to the cable, significantly increasing the flexibility of the heater cable 10. Furthermore, twisting the bus wires 12, 14 as described reduces the EMI emitted by the heater cable 10 because induced currents on adjacent twists in the bus wires 12, 14 tend to cancel each other out.

The twists may be uniform, having the same pitch and spacing along the entire heater cable 10, or the twists may be non-uniform. In one embodiment, the twisting arranges the bus wires 12, 14 in a helical parallel configuration with a uniform twist length (i.e., the distance for the heating element to rotate 180 degrees) of 0.75 inches along the heater cable 10. In some alternative embodiments, the heating element may be twisted only within one or more portions of the heater cable 10. In some alternative embodiments, only a subset of the components of the heating element may be twisted. For example, the bus wires 12, 14 in the heating element 200 of FIG. 2A may be twisted with the PTC core 18, and the PTC layer 20 may be extruded on top of the twisted bus wires 12, 14.

The heater cable 10 may include a polymer jacket 22 that provides dielectric separation from the heating element while allowing conductance of heat away from the heating element. For example, the polymer jacket 22 may be made from a thin polymer jacket, or may be formed of rubber, Teflon, or another environmentally resilient material. In one embodiment, the polymer jacket 22 may be extruded or molded about the heating element, while in another embodiment the polymer jacket 22 may be a wrapped jacket wrapped around the heating element. In one embodiment, the polymer jacket 22 may be disposed over the heating element after the heating element is twisted. In another embodiment, shown in FIG. 1, the polymer jacket 22 may be twisted with the heating element.

The heater cable 10 may further include a ground plane layer 24. This ground plane layer 24 may be constructed of braided metal (e.g., steel, copper, tin, aluminum, etc.) braided about the polymer jacket 22, or may be composed of wrapped metal (e.g., steel, copper, tin, aluminum, etc.) foil and a drain wire for ampacity. As shown, the ground plane layer 24 may be disposed over the polymer jacket 22 after the heating element and polymer jacket 22 have been twisted. Thus, the ground plane layer 24 is not twisted, and instead may be configured to fit tightly around the polymer jacket 22, conforming to the helical contour as shown in FIG. 1. This facilitates bending of the heater cable in the plane of the heating element's minor axis, during which the ground plane layer 24 may expand or contract accordingly. The ground plane layer 24 may provide an earth ground for the heater cable 10, can provide additional strength to the heater cable 10, and can aid in heat transfer away from the polymer jacket 22 and monolithic heater element 18 toward the exterior surface of the heater cable 10.

The heater cable 10 may further include an outer jacket 26 surrounding the ground plane layer 24 or another layer. The outer jacket 26 may be a thin, flexible layer, such as a thin polymer jacket, or may be formed of rubber, Teflon, or another material that is also environmentally resilient and, in particular, is impermeable to water and/or to typical flooring adhesives such as thinset. In one embodiment, the outer jacket 26 may be extruded over the ground plane layer 24. In another embodiment, the outer jacket 26 may be wrapped around the heater cable 10. Such a wrapped outer jacket may provide an articulated outer surface which results in increased flexibility for ease of installation, which may better accommodate movement and handling of the heater cable 10 during installation and thereafter. An extruded or wrapped outer jacket 26 may have a uniform thickness and can conform to the shape of the layer(s) underneath. Thus, as shown in FIGS. 3 and 4 (cross-sections of the heater cable of FIG. 1), when the underlying layers (i.e., the, ground plane layer 24) conform to the helical or otherwise twisted contour of the twisted heating element, the outer jacket 26 may also conform to the twisted contour, such that a major axis (i.e., through the bus wires 12, 14) and a minor axis (i.e., perpendicular to and at the midpoint of the major axis) of the outer jacket 26 have an orientation that rotates with the twist of the heating element. As described above, this enables the laterally elongated heater cable 10 to be bent in multiple directions (i.e., around the major axis); furthermore, the outer surface provides a visual indicator of the optimal bend direction.

Referring to FIGS. 5 and 6, another exemplary heater cable 100 may have the components as described above, except that the extruded or wrapped outer jacket 126 may have a circular cross-section in the twisted portions of the heater cable 100. In such embodiments, where the outer jacket 126 is disposed over a layer that conforms to the helical contour (e.g., the ground plane layer 24 of FIG. 1), the outer jacket 126 may extend from the outer surface into contact with the underlying layer; thus, portions of the outer jacket 126 disposed over the major axis of the underlying layers may be thicker than portions of the outer jacket 126 disposed over the minor axis (i.e., over the ends) of the underlying layers. The material of the outer jacket 126 may have a suitable flexibility that facilitates the bending of the heater cable around the rotating major axis of the heating element (i.e., in a first orientation 500 and a second orientation 600 occurring at different points along the longitudinal axis of the heater cable 100), even when the bend direction is against the thicker portions of the outer jacket 126. Alternatively, the outer jacket 26 may have a uniform thickness, and voids between the outer jacket 26 and the layer over which it is disposed may be filled with air or another suitable substance.

Many variations for the ultimate construction of the heater cable 10 are contemplated, including the use of multiple additional varying metallic layers (e.g., a foil layer) and dielectric layers and/or the omission of one or more of the layers described above. These variations can be numerous and may depend on the particular application setting. However, in various embodiments, the use of a twisted or helical arrangement of the bus wires 12, 14, as described herein, is utilized to provide the realized benefits discussed herein.

The present invention has been described in terms of one or more preferred embodiments, and it should be appreciated that many equivalents, alternatives, variations, and modifications, aside from those expressly stated (e.g., methods, product by process, and so forth), are possible and within the scope of the invention.

We claim:

1. A heater cable comprising:
a heating element comprising:
a first bus wire and a second bus wire; and
a positive temperature coefficient (PTC) core in electrical contact with each of the at least two bus wires to make the heater cable self-regulating, the PTC core spacing the first bus wire a first distance from the second bus wire such that a cross-section of the heating element that is orthogonal to a longitudinal axis of the heater cable has a minor axis and a major axis that is perpendicular to and longer than the minor axis;
a first polymer jacket disposed over the heating element;
a ground plane layer disposed over the first polymer jacket; and
a second polymer jacket disposed over the ground plane layer and over the first polymer jacket, the second polymer jacket providing an outer surface of the heater cable;
wherein the heating element is twisted around the longitudinal axis along a length of the heater cable such that the minor axis has a first orientation at a first point along the length and a second orientation perpendicular to the first orientation at a second point along the length; and
wherein the second polymer jacket is not twisted around the longitudinal axis at any point along the length,

2. The heater cable of claim 1, wherein the heating element is twisted such that the first and second bus wires are disposed in a helical parallel configuration along the length of the heater cable.

3. The heater cable of claim 1, wherein the heating element is twisted with a uniform twist length.

4. The heater cable of claim 3, wherein the second polymer jacket has a diameter of about 0.25 inches and the twist length is about 0.75 inches.

5. The heater cable of claim 1, wherein the ground plane layer is a braided metal and is not twisted around the longitudinal axis at any point along the length.

6. The heater cable of claim 5, wherein the first polymer jacket is not twisted around the longitudinal axis at any point along the length.

7. The heater cable of claim 1, wherein the second polymer jacket has a diameter of about 0.25 inches.

8. The heater cable of claim 7, wherein the second polymer jacket is wrapped around the ground plane layer and the first polymer jacket, such that the outer surface of the heater cable is articulated.

9. A heater cable comprising:
a first bus wire and a second bus wire; and
a positive temperature coefficient (PTC) core in electrical contact with each of the first and second bus wires and spacing the first bus wire from the second bus wire;
wherein the first bus wire and the second bus wire are twisted around a longitudinal axis of the heater cable for at least a portion of a total length of the heater cable.

10. The heater cable of claim 9, wherein the first bus wire and the second bus wire are twisted into a parallel, helical configuration.

11. The heater cable of claim 9, further comprising an outer jacket disposed over the First and second bus wires and the at least one PTC core, the outer jacket being untwisted around the longitudinal axis of the heater cable.

12. The heater cable of claim 11, further comprising:
a polymer jacket disposed over the first and second bus wires; and
a braided metal layer disposed over the polymer jacket, the outer jacket being disposed over the braided metal layer, wherein the braided metal layer is untwisted around the longitudinal axis of the heater cable.

13. The heater cable of claim 12, wherein the polymer jacket is untwisted around the longitudinal axis of the heater cable.

14. The heater cable of claim 12, wherein the polymer jacket is twisted together with the first and second bus wires around the longitudinal axis of the heater cable.

15. The heater cable of claim 11, wherein along the total length of the heater cable, the outer jacket has a circular cross-section and an outer diameter of about 0.25 inches.

16. The heater cable of claim 11, wherein the outer jacket has a first axis passing through the first and second bus wires, and a second axis perpendicular to and shorter than the first axis, an orientation of the first and second axes rotating together with the twisting of the first bus wire and the second bus wire.

17. A method of manufacturing a heater cable, the method comprising:
passing at least two bus wires and a positive temperature coefficient (PTC) material through an extruder to form a heating element in which the PTC material spaces the at least two bus wires a first distance apart;
twisting the heating element around a longitudinal axis of the heater cable; and
disposing an outer jacket over the heating element.

18. The method of claim 17, wherein disposing the outer jacket comprises extruding the outer jacket over the heating element after the heating element is twisted, such that the outer jacket has a first width and a second width perpendicular to and shorter than the first width and an orientation of the first and second widths rotates together with the twisting of the heating element.

19. The method of claim 17, wherein twisting the heating element comprises twisting the heating element with a uniform twist length along a length of the heating element to form a helical heating element in which the at least two bus wires are disposed in a parallel, helical configuration.

20. The method of claim 17, wherein passing the at least two bus wires and the PTC material through the extruder comprises setting the first distance such that the outer jacket can have a minimum diameter of 0.25 inches.
